(19) United States
(12) Patent Application Publication
(10) Pub. No.: US 2014/0218618 A1
(43) Pub. Date: Aug. 7, 2014

(54) Display Device

(71) Applicant: Funai Electric Co., Ltd., Osaka (JP)

(72) Inventors: Hiromasa SASAOKA, Daito-shi (JP); Akifumi KONO, Daito-shi (JP)

(73) Assignee: Funai Electric Co., Ltd., Osaka (JP)

(21) Appl. No.: 14/165,955

(22) Filed: Jan. 28, 2014

(30) Foreign Application Priority Data
Feb. 5, 2013 (JP) 2013-020897

(51) Int. Cl. F21V 8/00; H04N 5/64

(52) U.S. Cl. CPC G02B 6/0085; G02B 6/009; G02B 6/0073; H04N 5/64
USPC 348/725; 362/611; 362/612

(57) ABSTRACT

A display device includes a display device body, a display portion arranged on the front side, a light source, a light source substrate, a light guide plate having a light incident surface, and a heat sink arranged to be opposed to the light incident surface of the light guide plate between the light guide plate and the light source substrate, including a light source arrangement hole configured to arrange the light source and a spacer portion arranged to be opposed to the light incident surface of the light guide plate between the light guide plate and the light source substrate and keeping an interval between the light incident surface of the light guide plate and the light source at a prescribed interval.

### BACKGROUND OF THE INVENTION

1. Field of the Invention

The present invention relates to a display device, and more particularly, it relates to a display device including a light guide plate and a heat sink.

2. Description of the Background Art

A display device including a light guide plate and a heat sink is known in general, as disclosed in Japanese Patent Laying-Open No. 2007-026916, for example.

The aforementioned Japanese Patent Laying-Open No. 2007-026916 discloses a liquid crystal display module (display device) including a liquid crystal display module body (display device body) and a liquid crystal display panel (display portion) arranged on the front side of the liquid crystal display module body, displaying an image. This liquid crystal display module includes LEDs (light source) supplying light, to the liquid crystal display panel, a PCB (light source board) mounted with the LEDs, and a light, guide plate having a light incident surface receiving light, emitted from the LEDs, guiding the light to the liquid crystal display panel. This liquid crystal display module further includes a heat radiation cover (heat sink) arranged to be opposed to the light incident surface of the light guide plate.

The PCB is fixed to the heat radiation cover in a state where the LEDs are arranged in through-holes formed in the heat radiation cover. It is unclear whether or not a spacer member is provided between the light guide plate and the PCB when the light guide plate is arranged in the liquid crystal display module body.

In the liquid crystal display module according to the aforementioned Japanese Patent Laying-Open No. 2007-026916, however, an interval between the light incident surface of the light guide plate and the LEDs mounted on the PCB cannot be stably kept at a prescribed interval when no spacer member is provided between she light guide plate and the PCB, and hence the light emitted from the LEDs cannot be stably incident on the light guide plate. On the other hands, a dedicated spacer member is required when the dedicated spacer member keeping the interval between the light incident surface of the light guide plate and the LEDs mounted on the PCB at the prescribed interval is provided between the light guide plate and the PCB, and hence the number of components is disadvantageously increased.

### SUMMARY OF THE INVENTION

The present invention has been proposed in order to solve the aforementioned problem, and an object of the present invention is to provide a display device allowing light emitted from a light source to stably enter the light guide plate while suppressing an increase in the number of components.

A display device according to an aspect of the present invention includes a display device body, a display portion arranged on the front side of the display device body, displaying an image, a light source supplying light to the display portion, a light source substrate mounted with the light source, a light guide plate having a light incident surface receiving light emitted from the light source, guiding the light to the display portion, and a heat sink arranged to be opposed to the light incident surface of the light guide plate between the light guide plate and the light source substrate, including a light source arrangement hole configured to arrange the light source and a spacer portion arranged to be opposed to the light incident surface of the light guide plate between the light guide plate and the light source substrate and keeping an interval between the light incident surface of she light guide plate and the light source at a prescribed interval.

In the display device according so the aspect of the present invention, as hereinabove described, the heat sink is arranged to be opposed to the light incident surface of the light guide plate between the light guide plate and the light source substrate, and the spacer portion keeping the interval between the light incident surface of the light guide plate and the light source at the prescribed interval is provided, whereby the interval between the light incident surface of the light guide plate and the light source can be kept constant by the spacer portion, and hence variation in the interval between the light incident surface of the light guide plate and the light source can be suppressed. Consequently, the light emitted from the light source can be stably incident on the light guide plate, and hence the number of light sources (the number of components) can be reduced as compared with the case where an excessive number of the light sources are provided in advance in consideration of the variation in the interval between the light incident surface of the light guide plate and the light source. Furthermore, the heat sink, including the spacer portion keeping the interval between the light incident surface of the light guide plate and the light source at the prescribed interval is provided, whereby the heat sink, is also used as a spacer member keeping the interval between the light incident surface of the light guide plate and the light source at the prescribed interval, and hence no dedicated spacer member keeping the interval between the light incident surface of the light guide plate and the light source at the prescribed interval may be separately provided, so that an increase in the number of components can be suppressed. In this display device, therefore, the light emitted from the light source can be stably incident on the light guide plate while the increase in the number of components is suppressed.

Furthermore, die heat sink is provided to be opposed to the light incident surface of the light guide plate between the light guide plate and the light source substrate, and the light source arrangement hole configured to arrange the light source in the heat sink is provided between the light guide plate and the light source substrate, whereby the heat sink (spacer portion) can be arranged between the light incident surface of the light guide plate and a surface of the light source substrate opposed to the light guide plate in the state where the light source is arranged in the light source arrangement hole, and hence the heat sink (spacer portion) and the light source overlap with each other, so that the width of a frame can be reduced. In addition, the light guide plate can extend to the outside of the display device body and be largely formed instead of reducing the width of the frame by overlapping the heat sink (spacer portion) with the light source. Thus, a light path length from the light incident surface of the light guide plate to a portion corresponding to an image display area can be increased, and hence the light, emitted from the light, source can be spread and reach the portion corresponding to the image display area. Consequently, the number of the light sources can be reduced while unevenness in brightness on the display portion is suppressed.

In the aforementioned display device according to the aspect, the light incident surface of the light guide plate is preferably configured to come into contact with the spacer portion of the heat sink in a state where the light source is arranged in the light source arrangement hole of the heat sink. According to this structure, an interval between the light incident surface of the light guide plate and the spacer portion of the heat sink can be reliably fixed (maintained), and hence the interval between the light incident surface of the light guide plate and the light source can be easily kept constant. Thus, the light emitted from the light source can be more stably incident on the light guide plate.

In this case, the light incident surface of the light guide plate is preferably substantially flat, and the spacer portion is preferably formed such that a portion thereof opposed to the light incident surface of the light guide plate has a substantially flat surface. According to this structure, the light incident surface of the light guide plate and the spacer portion of the heat sink can be brought into close contact with each other, and hence the interval between the light incident surface of the light guide plate and the spacer portion of the heat sink can be stably maintained.

In the aforementioned display device according to the aspect, the spacer portion preferably has a thickness larger than the protrusion height of the light source from a mounting surface of the light source substrate in a state where the light source is arranged in the light source arrangement hole. According to this structure, the spacer portion can easily, reliably keep the interval, between the light incident surface of the light guide plate and the light source constant while preventing contact of the light source arranged in the light source arrangement hole with the light incident surface of the light guide plate.

In the aforementioned display device according to the aspect, the light source is preferably mounted on a surface of the light source substrate opposed to the light guide plate, and the light source substrate is preferably configured such that the surface thereof opposed to the light guide plate is fixed to a surface of the spacer portion opposite to a side opposed to the light guide plate. According to this structure, the light source can be easily arranged in the light source arrangement hole when the light source substrate is fixed to the heat sink.

In the aforementioned display device according to the aspect, the light source substrate preferably includes a wiring pattern, and a larger number of wiring patterns are preferably provided in the vicinity of a surface of the light source substrate closer to the heat sink than in the vicinity of a surface of the light source substrate opposite to the heat sink. According to this structure, heat generated from the wiring patterns can be easily transferred to the heat sink, and hence the heat radiation efficiency can be improved.

The aforementioned display device according to the aspect preferably further includes an urging member urging the light guide plate toward the spacer portion in a state where the light source is arranged in the light source arrangement hole. According to this structure, separation of the spacer portion and the light incident surface of the light guide plate from each other can be suppressed, and hence the interval between the light incident surface of the light guide plate and the light source can be reliably kept constant.

In this case, a plurality of urging members are preferably provided, and the plurality of urging members are preferably provided at positions on both end sides of the light incident surface of the light guide plate, respectively. According to this structure, the light guide plate can be urged toward the spacer portion in a balanced manner by the plurality of urging members.

In the aforementioned display device according to the aspect, a plurality of light sources are provided, the spacer portion preferably includes a plurality of light source arrangement holes at positions corresponding to the plurality of light sources, and the light guide plate is preferably arranged to come into contact with a region of the spacer portion between the plurality of light source arrangement holes adjacent to each other. According to this structure, an interval between the light incident surface of the light guide plate and any of the plurality of light sources can be kept constant by the region of the spacer portion between the plurality of light source arrangement holes. Consequently, light emitted from the plurality of light sources can be stably incident on the light guide plate even in the case where there are the plurality of light sources.

In this case, the region of the spacer portion between the plurality of light source arrangement holes adjacent to each other preferably has a width equal to or more than the thickness of the light guide plate in an anteroposterior direction. According to this structure, a contact area between the light, incident surface of the light guide plate and the spacer portion of the heat sink can be easily increased, and hence the interval between the light, incident surface of the light guide plate and the spacer portion of the heat sink can be easily, stably maintained.

The aforementioned display device according to the aspect preferably further includes a rear frame arranged on the rear side of the heat sink, and the light source substrate is preferably fixed to a surface of the spacer portion opposite to a side opposed to the light guide plate in a state where the rear side end surface of the light source substrate is separated from the front side of the rear frame at a prescribed interval. According to this structure, the dimension error of the light source substrate can be absorbed by the prescribed interval between the rear side end surface of the light source substrate and the front side of the rear frame even when there is the dimension error in the light source substrate, and hence the light source substrate can be accurately fixed to the heat sink. Consequently, positional displacement between the light source mounted on the light source substrate and the light incident surface of the light guide plate can be suppressed, and hence the light emitted from the light source can be more stably incident on the light guide plate.

In this case, the light source substrate preferably includes a first positioning portion, and the spacer portion preferably includes a second positioning portion corresponding to the first positioning portion. According to this structure, the light source substrate can be arranged in a state where the same is positioned with respect to the spacer portion by the first positioning portion and the second positioning portion, and hence the positional displacement between the light source mounted on the light source substrate and the light incident surface of the light guide plate can be further suppressed. Consequently, the light emitted from the light source can be more stably incident on the light, guide plate.

The aforementioned display device according to the aspect preferably further includes a second heat sink provided separately from a first heat sink as the heat sink, arranged on a surface of the light source substrate opposite to a side on which the first heat sink is arranged. According to this structure, heat can be radiated by the second heat sink in addition to the first heat sink, and hence the heat radiation efficiency can be further improved.

In the aforementioned display device according to the aspect, the light source and the light source arrangement hole are preferably formed in shapes corresponding to each other, as viewed from the side of the light incident surface of the light guide plate. According to this structure, the light source can be easily arranged in the light source arrangement hole.

In the aforementioned display device according to the aspect, the light source preferably includes an LED light source, and the LED light source is preferably arranged in the light source arrangement hole. According to this structure, the size of the light source arrangement hole can be reduced, and hence the size of the spacer portion provided in a region between the light guide plate and the light source substrate can be increased. Consequently, the interval between the light incident surface of the light guide plate and the light source can be easily kept constant.

In the aforementioned structure including the rear frame, the rear frame preferably includes a restriction portion restricting the movement of the heat sink in a state where the light source is arranged in the light source arrangement hole of the heat sink and the light incident surface of the light guide plate comes into contact with the spacer portion of the heat sink. According to this structure, the restriction portion can suppress the movement of the heat sink in the state where the light incident surface of the light guide plate comes into contact with the spacer portion of the heat sink, and hence the interval, between the light incident surface of the light guide plate and the light source can be reliably kept constant.

In the aforementioned display device according to the aspect, the heat sink is preferably made of a plate-like metal material. According to this structure, the heat sink is hardly influenced by heat unlike the case where the heat sink is made of resin, for example, and hence large deformation of the heat sink resulting from heat can be suppressed. Consequently, the interval between the light incident surface of the light guide plate and the light source can be reliably kept constant.

The aforementioned display device according to the aspect is preferably a television set including a receiver receiving television broadcasting. The present invention is also applicable to the television set.

According to the present invention, as hereinabove described, the light emitted from the light source can be stably incident on the light guide plate while the increase in the number of components is suppressed.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a diagram showing the overall, structure of a TV according to a first embodiment of the present invention;

FIG. 2 is a diagram showing a contact portion between a light guide plate and a heat sink of the TV according to the first embodiment of the present invention;

FIG. 3 is an enlarged view showing the heat sink and an LED module of the TV according to the first embodiment of the present invention;

FIG. 4 is a sectional view taken along the line 500-500 in FIG. 1;

FIG. 5 is a diagram showing an LED substrate fixed to a spacer portion of the TV according to the first embodiment of the present invention;

FIG. 6 is a diagram showing a heat sink and an LED module of a TV according to a second embodiment of the present invention;

FIG. 7 is a diagram showing an LED substrate fixed so a heat sink of a TV according to a first modification of the first embodiment of the present invention;

FIG. 8 is a diagram showing an LED substrate on which a second heat sink of a TV according to a second modification of the first embodiment of the present invention is arranged;

FIG. 9 is a diagram showing a spacer portion of a TV according to a third modification of the first embodiment of the present invention; and

FIG. 10 is a diagram showing an urging member of a TV according to a fourth modification of the first embodiment of the present invention.

### DESCRIPTION OF THE PREFERRED EMBODIMENTS

Embodiments of the present invention are hereinafter described with reference to the drawings.

### First Embodiment

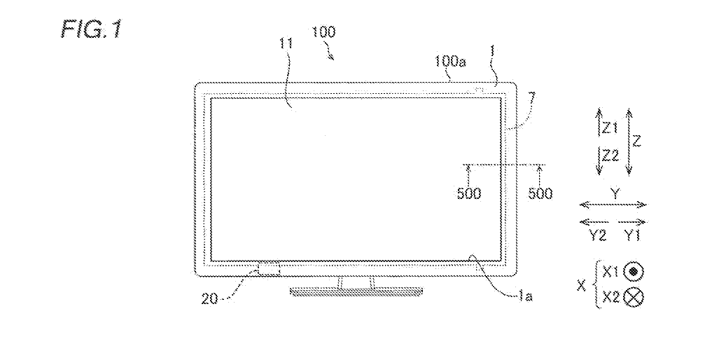

The structure of a TV (television set) 100 according to a first embodiment of the present invention is now described with reference to FIGS. 1 to 5. The TV 100 is an example of the “display device” in the present invention.

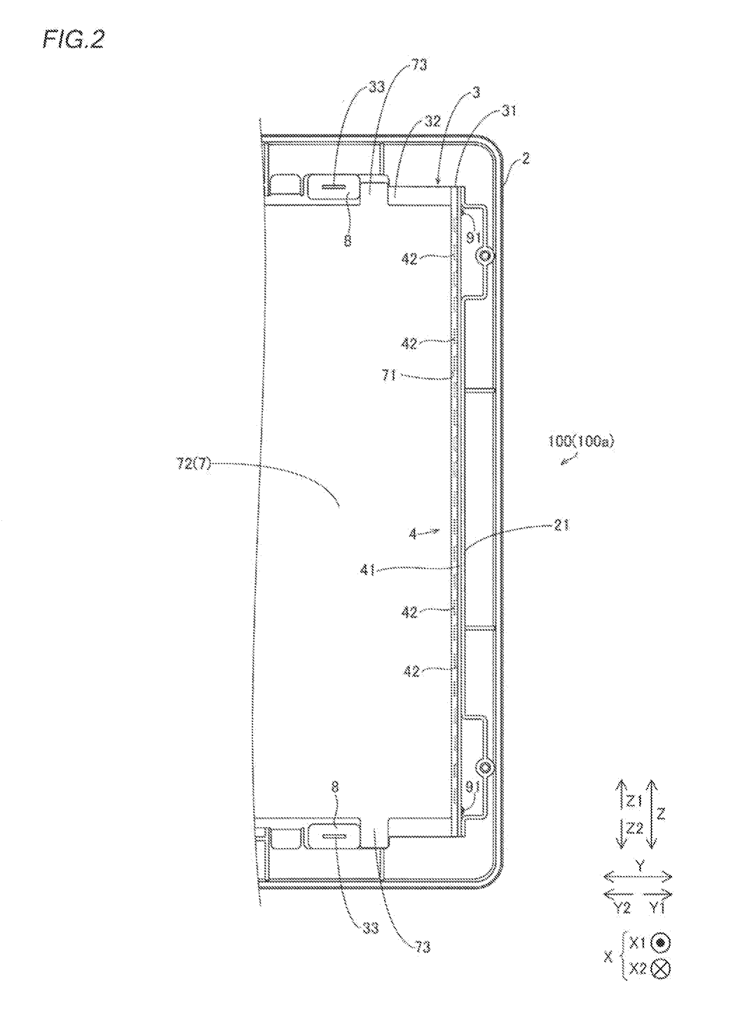

The TV 100 according to the first embodiment of the present invention includes a front frame 1 and a rear frame 2 (see FIG. 2), as shown in FIG. 1. A display portion 11 displaying an image is exposed from an opening 1a of the front frame 1. The TV 100 is configured to be capable of receiving a broadcast signal through a receiving portion 20.

Inside the TV 100, a heat sink 3 and an LED module 4 including a plurality of LEDs 42 (see FIG. 2) are provided, as shown in FIGS. 2 and 4. As shown in FIG. 4, a supporting member 5, a reflective sheet 6, a light guide plate 7, silicon rubbers 8 (see FIG. 2), and an optical sheet 9 are arranged on the front side (X1 side) of the heat sink 3. On the front side of she light guide plate 7, a resin frame 10 is arranged. On the front side of the resin frame 10, the display portion 11 displaying an image is arranged. The LEDs 42 are examples of the “light source” in the present invention.

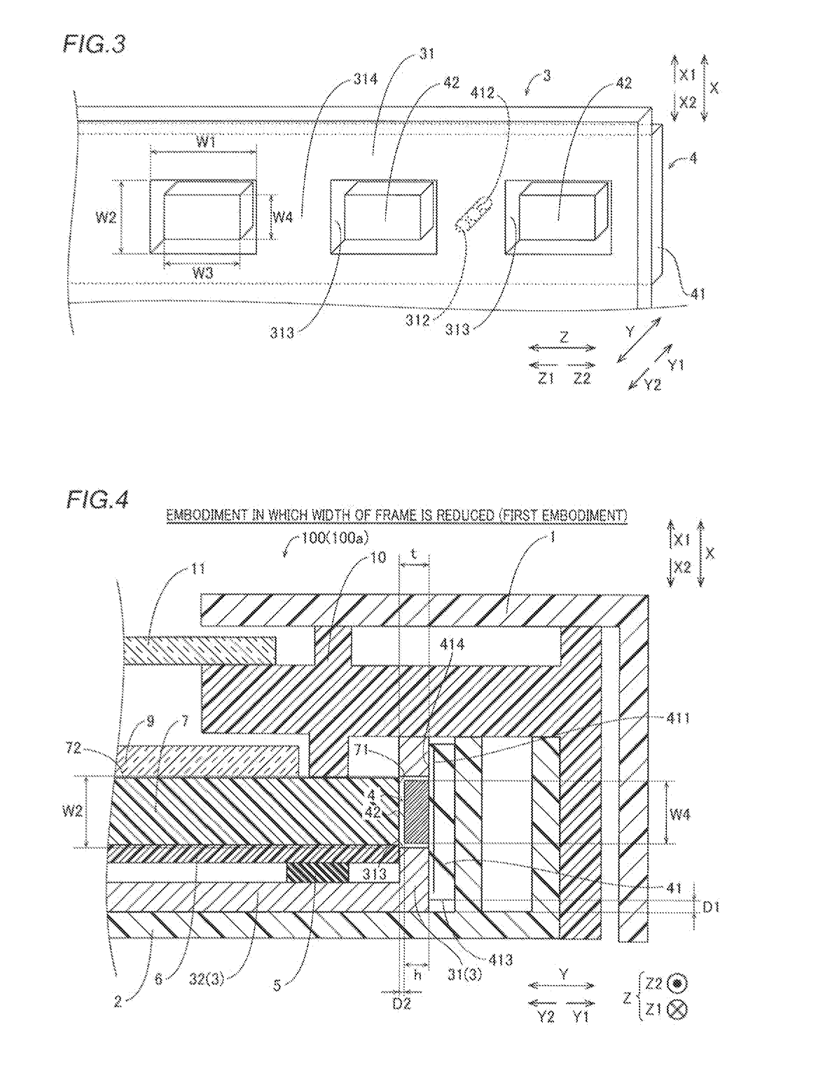

According to the first embodiment, the heat sink 3 is arranged on the front side (X1 side) of the rear frame 2, as shown in FIG. 4. The heat sink 3 includes a plurality of LED arrangement holes 313 arranged between the light guide plate 7 and an LED substrate 41 to be opposed to the light incident surface 71 of the light guide plate 7, configured to arrange the LEDs 42. The heat sink 3 further includes a spacer portion 31 arranged between the light guide plate 7 and the LED substrate 41 to be opposed to the light incident surface 71 of the light guide plate 7, keeping an interval between the light incident surface 71 of the light guide plate 7 and the LEDs 42 at a prescribed interval. Specifically, the spacer portion 31 is formed such that a portion thereof opposed to the substantially flat light incident surface 71, described, later, of the light guide plate 7 has a substantially flat surface. The spacer portion 31 is formed by substantially vertically bending an edge of the heat sink 3 to the X1 side. The spacer portion 31 is formed on the Y1 side of the heat sink 3, as shown in FIGS. 2 to 5. The spacer portion 31 includes the plurality of LED arrangement holes 313 at positions corresponding to the plurality of LEDs 42, as shown in FIG. 3. The LED arrangement holes 313 are provided in the same number as that of the LEDs 42. The LED arrangement holes 313 each have a width W1 in a direction Z. The LED arrangement holes 313 each have a width W2 in a direction X. A region 314 of the spacer portion 31 between the plurality of LED arrangement holes 313 adjacent to each other has a width W2 equal to or more than the thickness of the light guide plate 7 in an anteroposterior direction. The LEDs 42 and the LED arrangement holes 313 are formed in shapes (substantially rectangular shapes) corresponding so each other, as viewed from the side (Y2 side) of the light incident surface 71 of the light guide plate 7. The spacer portion 31 has a thickness t larger than the protrusion height h of the LEDs 42 from a mounting surface 414 of the LED substrate 41 described later in a state where the LEDs 42 are arranged in the LED arrangement holes 313, as shown in FIG. 4.

The spacer portion 31 includes screw holes 312 in both ends (see. FIG. 2) in the direction Z, as shown in FIG. 5. The heat sink 3 includes a flat portion 32 extending in a Y-Z plane, as shown in FIGS. 2, 4, and 5. As shown in FIG. 2, fixing portions 33 substantially vertically bent to the X1 side are formed in the vicinity of the spacer portion 31 of the heat sink 3. The fixing portions 33 are formed on both ends of the heat sink 3 in the direction 5, respectively. The heat sink 3 is configured such that the movement thereof along arrow Y1 is restricted by a restriction portion 21 formed on the Y1 side of the rear frame 2. Specifically, the restriction portion 21 is configured to restrict the movement of the heat sink 3 in a state where the LEDs 42 are arranged in the LEN arrangement holes 313 of the heat sink 3 and the light incident surface 71 of the light guide plate 7 comes into contact with the spacer portion 31 of the heat sink 3. The heat sink 3 is made of metal (sheet metal). The LED arrangement holes 313 are examples of the “light source arrangement hole” in the present invention. The screw holes 312 are examples of the “First positioning portion” in the present invention.

According to the first embodiment, the LED module 4 mainly includes the LED substrate 41 and the plurality of LEDs 42 mounted on the LED substrate 41, as shown in FIGS. 2 to 4. The LED module 4 is configured to supply light to the display portion 11. The LED module 4 is arranged on the right side (Y1 side) when a TV body 100a (see FIG. 1) is viewed from the front side. The LED substrate 41 roughly has a substantially rectangular shape, as shown in FIG. 3. The LED substrate 41 includes wiring patterns 411. Specifically, a larger number of the wiring patterns 411 are provided in the vicinity of a surface of the LED substrate 41 closer to the heat sink 3 (Y2 side) than in the vicinity of a surface of the LED substrate 41 opposite to the heat sink 3, as shown in FIGS. 4 and 5. The LED substrate 41 is configured such that a surface thereof opposed (Y2 side) to the light guide plate 7 is fixed to a surface of the spacer portion 31 opposite to a side opposed to the light guide plate 7. The LED substrate 41 is an example of the “light source substrate” in the present invention. The TV body 100a is an example of the “display device body” in the present invention.

The LED substrate 41 includes screw holes 412, as shown in FIG. 5. The screw holes 412 are configured to correspond to the screw holes 312 of the heat sink 3 (spacer portion 31). Screws 91 are inserted into the screw holes 412 of the LED substrate 41 and the screw holes 312 of the spacer portion 31 (heat sink 3), whereby the LED substrate 41 is fixed to the spacer portion 31. The LED substrate 41 is fixed to the surface of the spacer portion 31 opposite (Y1 side) to the side opposed to the light guide plate 7 in a state where a rear side end surface 413 of the LED substrate 41 is separated from the front side (X1 side) of the rear frame 2 at a prescribed interval D1, as shown in FIG. 4. The screw holes 412 are examples of the “second positioning portion” in the present invention.

As shown in FIG. 4, the LEDs 42 are mounted on a surface of the LED substrate 41 opposed (Y2 side) to the light guide plate 7. The LEDs 42 each have the protrusion height h along arrow Y2 from the mounting surface 414 of the LED substrate 41 mounted with the LEDs 42. The LEDs 42 each have a width W3 smaller than the width W1 of the LED arrangement holes 313 in the direction Z, as shown in FIG. 3. The LEDs 42 each have a width W4 smaller than the width W2 of the LED arrangement holes 313.

The supporting member 5 is arranged on the front side (X1 side) of the rear frame 2, as shown in FIG. 4. The supporting member 5 has a function of positioning the light guide plate 7 at a prescribed position in the direction X. The reflective sheet 6 is arranged on the rear side (X2 side) of the light guide plate 7. The reflective sheet 6 has a function of suppressing light leakage from the light guide plate 7 to the X2 side.

According to the first embodiment, the light guide plate 7 is configured such that the light incident surface 71 thereof comes into contact with the spacer portion 31 of the heat sink 3 in the state where the LEDs 42 are arranged in the LED arrangement holes 313 (see FIG. 3) of the heat sink 3, as shown in FIG. 2. The light incident surface 71 is a surface (Y1 side) of the light guide plate 7 coming into contact with the spacer portion 31. The light guide plate 7 has a function of guiding light to the display portion 11. The light incident surface 71 is substantially flat. The light guide plate 7 roughly has a substantially rectangular shape (see FIG. 1). The light incident surface 71 is opposed to the LEDs 42, as shown in FIGS. 2 and 4. Light incident on the light guide plate 7 is emitted from a light emitting surface 72. The light guide plate 7 is arranged to come into contact with the region 314 (see FIG. 3) between the plurality of LED arrangement holes 313 adjacent to each other.

The light guide plate 7 includes protrusion portions 73 provided on a pair of sides in the direction Z, as shown in FIG. 2. Specifically, the protrusion portions 73 are provided on both ends of the light guide plate 7 in the direction Z, respectively. The protrusion portions 73 are provided in the vicinity of the light incident surface 71 of the light guide plate 7 (Y1 side). As shown in FIG. 4, the light guide plate 7 is arranged such that the light incident surface 71 of the light guide plate 7 and the LEDs 42 are separated from each other at a prescribed interval D2 (0.3 mm, for example).

According to the first embodiment, the silicon rubbers 8 are fixed to the fixing portion 33 of the heat sink 3, as shown in FIG. 2. The silicon rubbers 8 are configured to urge the light guide plate 7 toward the spacer portion 31 in the state where the LEDs 42 are arranged in the LED arrangement holes 313. Specifically, the silicon rubbers 8 are configured to urge the protrusion portions 73 on both ends of the light guide plate 7 toward the spacer portion 31 (heat sink 3). The silicon rubbers 8 each have a substantially rectangular shape in a plan view. The silicon rubbers 8 are arranged at positions corresponding to a pair of protrusion portions 73 of the light guide plate 7. Two silicon rubbers 8 are provided. The two silicon rubbers 8 are arranged at positions on both end sides of the light incident surface 71 of the light guide plate 7, respectively. The silicon rubbers 8 are configured to be held between the light guide plate 7 (protrusion portions 73) and the fixing portions 33 of the heat sink 3 and be elastically deformed in a state where the silicon rubbers 8 and the light guide plate 7 are arranged on the heat sink 3. The silicon rubbers 8 are examples of the “urging member” in the present invention.

The optical sheet 9 is arranged on the front side (X1 side) of the light guide plate 7, as shown in FIG. 4. The resin frame 10 is configured to fix the light guide plate 7 to the TV body 100a. The display portion 11 is arranged on the front side of she optical sheet 9. The display portion 11 is mainly constituted by a liquid crystal cell.

According to the first embodiment, as hereinabove described, the heat sink 3 is arranged to be opposed to the light incident surface 71 of the light guide plate 7 between the light guide plate 7 and the LED substrate 41, and the spacer portion 31 keeping the interval between the light incident surface 71 of the light guide plate 7 and the LEDs 42 at the prescribed interval is provided. Thus, the interval between the light incident surface 71 of the light guide plate 7 and the LEDs 42 can be kept constant by the spacer portion 31, and hence variation in the interval between the light incident surface 71 of the light guide plate 7 and the LEDs 42 can be suppressed. Consequently, the light emitted from the LEDs 42 can be stably incident on the light guide plate 7, and hence the number of the LEDs 42 the number of components) can be reduced as compared with the case where an excessive number of the LEDs 42 are provided in advance in consideration of the variation in the interval between the light incident surface 71 of the light guide plate 7 and the LEDs 42. Furthermore, the heat sink 3 including the spacer portion 31 keeping the interval between the light incident surface 71 of the light guide plate 7 and the LEDs 42 at the prescribed interval is provided. Thus, the heat sink 3 is also used as a spacer member keeping the interval between the light incident surface 71 of the light guide plate 7 and the LEDs 42 at the prescribed interval, and hence no dedicated spacer member may be separately provided, so that an increase in the number of components can be suppressed. In this TV 100, therefore, the light emitted from the LEDs 42 can be stably incident on the light guide plate 7 while the increase in the number of components is suppressed.

Furthermore, she heat sink 3 is provided to be opposed to the light incident surface 71 of the light guide plate 7 between the light guide plate 7 and the LED substrate 41, and the LED arrangement holes 313 configured to arrange the LEDs 42 in the heat sink 3 are provided between the light guide plate 7 and the LED substrate 41. Thus, the heat sink 3 (spacer portion 31) can be arranged between the light incident surface 71 of the light guide plate 7 and the surface of the LED substrate 41 opposed to the light guide plate 7 in the state where the LEDs 42 are arranged in the LED arrangement holes 313, and hence the heat sink 3 (spacer portion 31) and the LEDs 42 overlap with each other, so that the width of a frame can be reduced.

According to the first embodiment, as hereinabove described, the light incident surface 71 of the light guide plate 7 is configured to come into contact with the spacer portion 31 of the heat sink 3. Thus, an interval between the light incident surface 71 of the light guide plate 7 and the spacer portion 31 of the heat sink 3 can be reliably fixed (maintained), and hence the interval between the light incident surface 71 of the light guide plate 7 and the LEDs 42 can be easily kept constant. Thus, the light emitted from the LEDs 42 can be more stably incident on the light guide plate 7.

According to the first embodiment, as hereinabove described, the light incident surface 71 of the light guide plate 7 is substantially flat, and the spacer portion 31 is formed such that the portion thereof opposed to the light incident surface 71 of the light guide plate 7 has the substantially flat surface. Thus, the light incident surface 71 of the light guide plate 7 and the spacer portion 31 of the heat sink 3 can be brought into close contact with each other, and hence the interval between the light incident surface 71 of the light guide plate 7 and the spacer portion 31 of the heat sink 3 can be stably maintained.

According to the first embodiment, as hereinabove described, the spacer portion 31 is configured to have the thickness larger than the protrusion height of the LEDs 42 from the mounting surface 414 of the LED substrate 41. Thus, the spacer portion 31 can easily, reliably keep the interval between the light incident surface 71 of the light guide plate 7 and the LEDs 42 constant while preventing contact of the LEDs 42 arranged in the LED arrangement holes 313 with the light incident surface 71 of the light guide plate 7.

According to the first embodiment, as hereinabove described, the LEDs 42 are mounted on the surface of the LED substrate 41 opposed to the light guide plate 7, and the LED substrate 41 configured such that the surface thereof opposed to the light guide plate 7 is fixed to the surface of the spacer portion 31 opposite to the side opposed to the light guide plate 7. Thus, the LEDs 42 can be easily arranged in the LED arrangement holes 313 when the LED substrate 41 is fixed to the heat sink 3.

According to the first embodiment, as hereinabove described, a larger number of the wiring patterns 111 are provided in the vicinity of the surface of the LED substrate 41 closer to the heat sink 3 than in the vicinity of the surface of the LED substrate 41 opposite to the heat sink 3. Thus, heat generated from the wiring patterns can be easily transferred to the heat sink 3, and hence the heat radiation efficiency can be improved.

According to the first embodiment, as hereinabove described, the silicon rubbers 8 urging the light guide plate 7 toward the spacer portion 31 are provided. Thus, separation of the spacer portion 31 and the light incident surface 71 of the light guide plate 7 from each other can be suppressed, and hence the interval between the light incident surface 71 of the light guide plate 7 and the LEDs 42 can be reliably kept constant.

According to the first embodiment, as hereinabove described, the two silicon rubbers 8 are arranged at the positions on both end sides of the light incident surface 71 of the light guide plate 7, respectively. Thus, the light guide plate 7 can be urged toward the spacer portion 31 in a balanced manner by the two silicon rubbers 8.

According to the first embodiment, as hereinabove described, the plurality of LED arrangement holes 313 are provided at the positions corresponding to the plurality of LEDs 42 in the spacer portion 31, and the light guide plate 7 is arranged to come into contact with the region 314 of the spacer portion 31 between the plurality of LED arrangement holes 313 adjacent to each other. Thus, an interval between the light incident surface 71 of the light guide plate 7 and any of the plurality of LEDs 42 can be kept constant by the region 314 between the plurality of LED arrangement holes 313. Consequently, the light emitted from the plurality of LEDs 42 can be stably incident on the light guide plate 7 even in the case where there are the plurality of LED 42.

According to the first embodiment, as hereinabove described, the region 314 of the spacer portion 31 between the plurality of LED arrangement holes 313 adjacent to each other has the width W2 equal to or more than the thickness of the light guide plate 7 in the anteroposterior direction. Thus, a contact area between the light incident surface 71 of the light guide plate 7 and the spacer portion 31 of the heat sink 3 can be increased, and hence the interval between the light incident surface 71 of the light guide plate 7 and the spacer portion 31 of the heat sink 3 can be easily, stably maintained.

According to the first embodiment, as hereinabove described, the rear frame 2 arranged on the rear side of the heat sink 3 is provided, and the LED substrate 41 is fixed to the spacer portion 31 in the state where the rear side end surface 413 of the LED substrate 41 is separated from the front side of the rear frame 2 at the prescribed interval.

Thus, the dimension error of the LED substrate 41 can be absorbed by the prescribed interval between the rear side end surface 412 of the LED substrate 41 and the front side of the rear frame 2 even when there is the dimension error in the LED substrate 41, and hence the LED substrate 41 can be accurately fixed to the heat sink 3. Consequently, positional displacement between the LEDs 42 mounted on the LED substrate 41 and the light incident surface 71 of the light guide plate 7 can be suppressed, and hence the light emitted from the LEDs 42 can be more stably incident on the light guide plate 7.

According to the first embodiment, as hereinabove described, the screw holes 412 are provided in the LED substrate 41, and the screw holes 312 corresponding to the screw holes 412 are provided in the spacer portion 31. Thus, the LED substrate 41 can be arranged in a state where the same is positioned with respect to the spacer portion 31 by the screw holes 412 and the screw holes 312, and hence the positional displacement between the LEDs 42 mounted on the LED substrate 41 and the light incident surface 71 of the light guide plate 7 can be further suppressed. Consequently, the light emitted from the LEDs 42 can be more stably incident on the light guide plate 7.

According to The first embodiment, as hereinabove described, the LEDs 42 and the LED arrangement holes 313 are formed in the shapes corresponding to each other, as viewed from the side of the light incident surface 71 of the light guide plate 7. Thus, The LEDs 42 can be easily arranged in the LED arrangement holes 313.

According to the first embodiment, as hereinabove described, the light source includes the LEDs 42, and the LEDs 42 are arranged in the LED arrangement holes 313. Thus, the size of the LED arrangement holes 313 can be reduced, and hence the size of the spacer portion 31 provided in a region between the light guide plate 7 and the LED substrate 41 can be increased. Consequently, the interval between the light incident surface 71 of the light guide plate 7 and the LEDs 42 can be easily kept constant.

According to the first embodiment, as hereinabove described, the restriction portion 21 restricting the movement of the heat sink 3 in the state where the LEDs 42 are arranged in the LED arrangement holes 313 of the heat sink 3 and the light incident surface 71 of the light guide plate 7 comes into contact with the spacer portion 31 of the heat sink 3 is provided in the rear frame 2. Thus, the restriction portion 21 can suppress the movement of the heat sink 3 in the state where the light incident surface 71 of the light guide plate 7 comes into contact with the spacer portion 31 of the heat sink 3, and hence the interval between the light incident surface 71 of the light guide plate 7 and the LEDs 42 can be reliably kept constant.

According to the first embodiment, as hereinabove described, the heat sink 3 is made of a plate-like metal material. Thus, the heat sink 3 is hardly influenced by heat unlike the case where the heat sink 3 is made of resin, for example, and hence large deformation of the heat sink 3 resulting from heat can be suppressed. Consequently, the interval between the light incident surface 71 of the light guide plate 7 and she LEDs 42 can be reliably kept constant.

### Second Embodiment

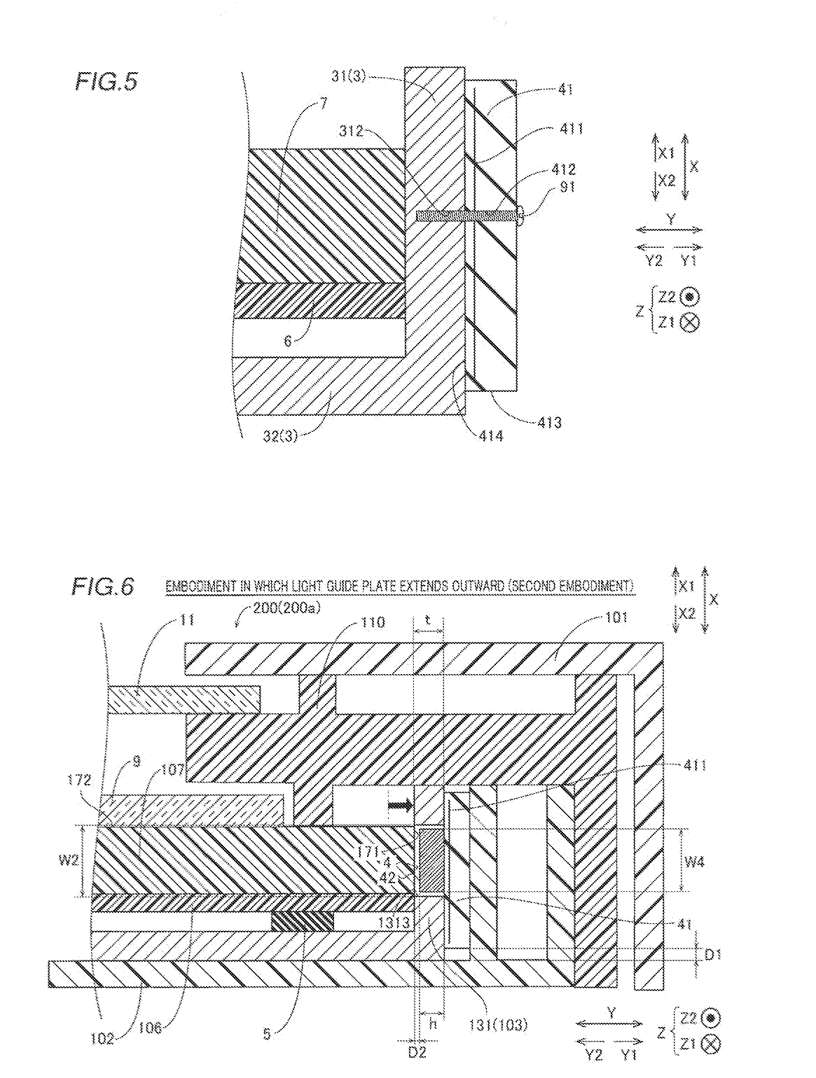

The structure of a TV 200 according to a second embodiment of the present invention is now described with reference to FIG. 6. The TV 200 is an example of the “display device” in the present invention.

In this second embodiment, the TV 200 has a light guide plate 107 extending to the outside of a TV body 200a and being largely formed, unlike in the first embodiment in which the spacer portion 31 and the LEDs 42 overlap with each other, so that the width of the frame of the TV body 100a is reduced. The TV body 200a is an example of the “display device body” in the present invention.

As shown in FIG. 6, the TV 200 according to the second embodiment includes a front frame 101 and a rear frame 102. Inside the TV 200, a heat sink 103 and an LED module 4 including a plurality of LEDs 42 are provided. Furthermore, a supporting member 5, a reflective sheet 6, the light guide plate 107, and an optical sheet 9 are arranged on the front side (X1 side) of the heat sink 103. On the front side of the light guide plate 107, a resin frame 110 is arranged. On the front side of the resin frame 110, a display portion 11 displaying an image is arranged. On the Y1 side of a spacer portion 131 of the heat sink 103, the LED module 4 is arranged.

The spacer portion 131 includes LED arrangement holes 1313 configured to arrange the LEDs 42, as shown in FIG. 6. The LEDs 42 are arranged in the LED arrangement holes 1313.

According to the second embodiment, the light guide plate 107 has a light incident surface 171 directly receiving light emitted from the LEDs 42, as shown in FIG. 6. The light incident surface 171 is configured to be opposed to the LEDs 42. The light incident on the light guide plate 107 is emitted from a light emitting surface 172. According to the second embodiment, the spacer portion 131 and the LEDs 42 overlap with each other, so that The light guide plane 107 is configured to extend (be increased in size) to the outside (Y1 side) of the TV body 200a, unlike the aforementioned first embodiment in which the spacer portion 31 and the LEDs 42 overlap with each other, so that the frame of the TV body 100a is reduced. In other words, the light guide plate 107 can be configured (increased in size) such that the light incident surface 171 extends to the outside of the TV body 200a by a portion along an arrow shown in FIG. 6, as compared with a light guide plate having an imago display area in the same size.

The remaining structure of the TV 200 accordion to the second embodiment is similar to the TV 100 accordion to the aforementioned first embodiment.

According to the second embodiment, as hereinabove described, the heat sink 103 is arranged to be opposed to the light incident surface 171 of the light guide plate 107 between the light guide plate 107 and LED substrate 41, and the spacer portion 131 keeping an interval, between the light incident surface 171 of the light guide plate 107 and the LEDs 42 at a prescribed interval is provided. Thus, the interval, between the light incident surface 171 of the light guide plate 107 and the LEDs 42 can be kept constant by the spacer portion 131, and hence variation in the interval between the light incident surface 171 of the light, guide plate 107 and the LEDs 42 can be suppressed. Consequently, the light emitted from the LEDs 42 can be stably incident on the light guide plate 107, and hence the number of the LEDs 42 can be reduced as compared with the case where an excessive number of the LEDs 42 are provided in advance in consideration of the variation in the interval between the light incident surface 171 of the light guide plate 107 and the LEDs 42. Furthermore, the heat sink 103 including the spacer portion 131 keeping the interval between the light incident surface 171 of the light guide plate 107 and the LEDs 42 at the prescribed interval is provided. Thus, the heat sink 103 is also used as a spacer member keeping the interval between the light incident surface 171 of the light guide plate 107 and the LEDs 42 at the prescribed interval, and hence no dedicated spacer member may be separately provided, so that an increase in the number of components can be suppressed. In this TV 200, therefore, the light emitted from the LEDs 42 can be stably incident on the light guide plate 107 while the increase in the number of components is suppressed.

According to the second embodiment, the light guide plate 107 can extend to the outside of the TV body 200a and be largely formed, unlike the first embodiment in which the heat sink 3 (spacer portion 31) and the LEDs 42 overlap with each other, so that the width of the frame is reduced. Thus, a light path length from the light, incident surface 171 of the light guide plate 107 to a portion corresponding to an image display area can be increased, and hence the light emitted from the LEDs 42 can be spread and reach the portion corresponding to the image display area. Consequently, the number of the LEDs 42 can be reduced while unevenness in brightness is suppressed.

The remaining effects of the second embodiment are similar to those of the aforementioned first embodiment.

The embodiments disclosed this time must be considered as illustrative in all points and not restrictive. The range of the present invention is shown not by the above description of the embodiments but by the scope of claims for patent, and all modifications within the meaning and range equivalent to The scope of claims for patent are further included.

For example, while the present invention is applied to the TV (television set) as the display device in each of the aforementioned first and second embodiments, the present invention is not restricted to this The present invention is also applicable to another display device, such as a monitor of a PC (personal computer).

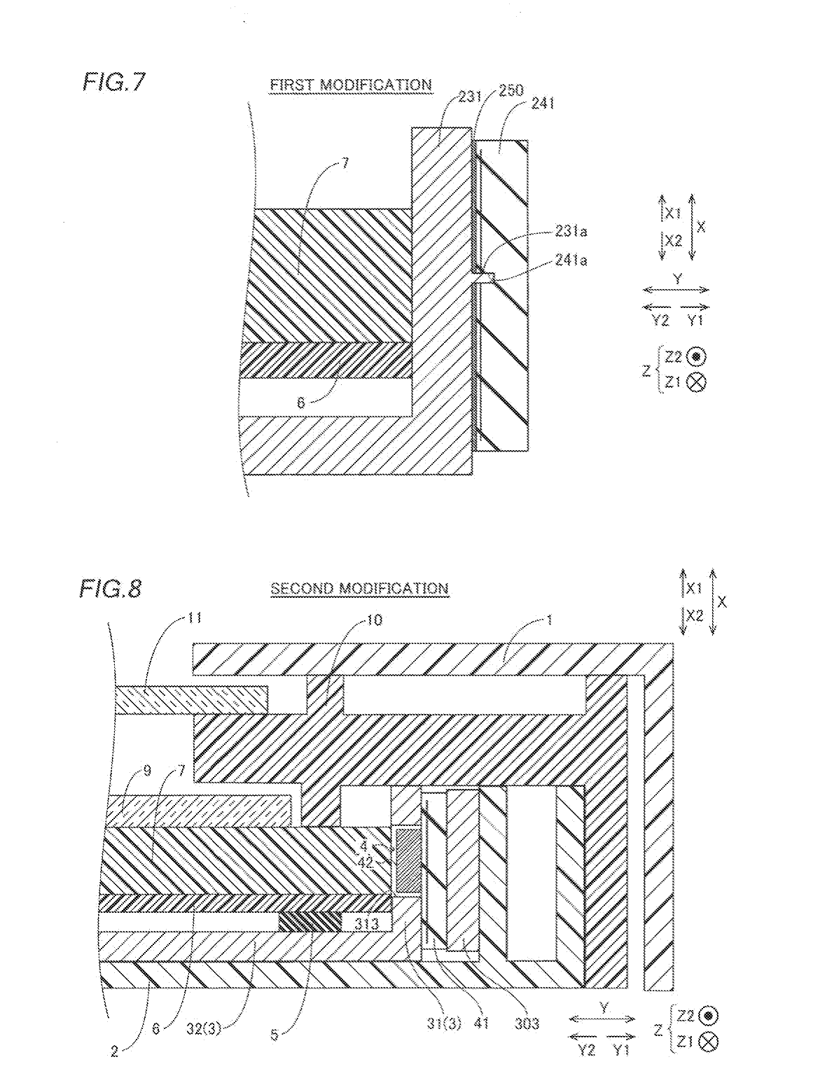

While the screw holes 412 as the first positioning portion according to the present invention are provided in the LED substrate (light source substrate), the screw holes 312 as the second positioning portion according to the present invention are provided in the spacer portion, and the screws are inserted into the screw holes 412 and the screw holes 312, so that the LED substrate is fixed to the spacer portion in each of the aforementioned first and second embodiments, the present invention is not restricted to this According to the present invention, recess portions 241a as the first positioning portion may alternatively be provided in a light source substrate 241, protrusion portions 231a as the second positioning portion may alternatively be provided in a spacer portion 231, and the light source substrate 241 may alternatively be fixed to the spacer portion 231 by a double-faced adhesive tape 250 in a state where the recess portions 241a engage with the protrusion portions 231a, as in a first modification shown in FIG. 7. Alternatively, protrusion portions as the first positioning portion may be provided in a light source substrate, recess portions as the second positioning portion may be provided in a spacer portion, and the recess portions may engage with the protrusion portions.

While the LED substrate (light source substrate) is fixed to the single heat sink in each of the aforementioned first and second embodiments, the present invention is not restricted to this. According to the present invention, a second heat sink provided separately from a first heat sink as the heat sink may alternatively be arranged on a surface of the light source substrate opposite to a side on which the first heat sink is arranged, utilizing a space generated by overlapping the spacer portion with the light source. Specifically, a first heat sink 3 may alternatively be arranged on the side of a light source substrate opposed to a light guide plate, and a second heat sink 303 may alternatively be arranged on the side of the light source substrate opposite to the side opposed to the light guide plate, as in a second modification shown in FIG. 8.

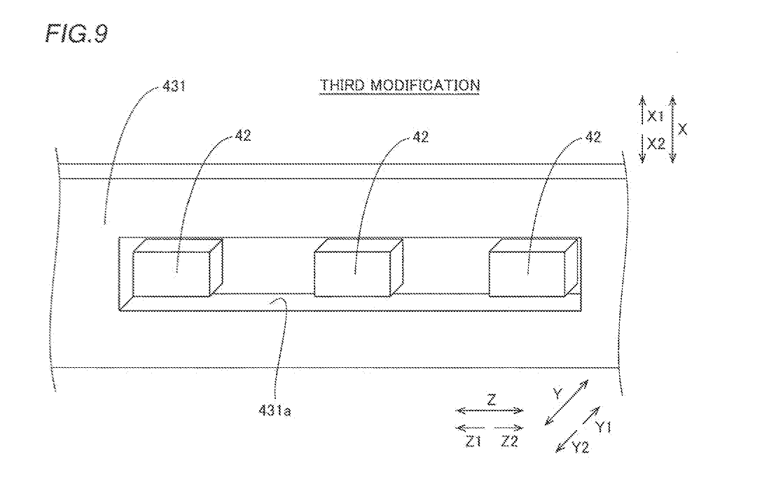

While the LED arrangement holes (light source arrangement holes) are provided in the same number as that of the plurality of LEDs (light sources) in the spacer portion in each of the aforementioned first and second embodiments, the present invention is not restricted to this. According to the present invention, the light source arrangement holes may not be provided in the same number as that of the light sources. Specifically, a light source arrangement hole 431a may alternatively be provided in a spacer portion 431 such that a plurality of light sources can be arranged in the single light source arrangement hole, as in a third modification shown in FIG. 9.

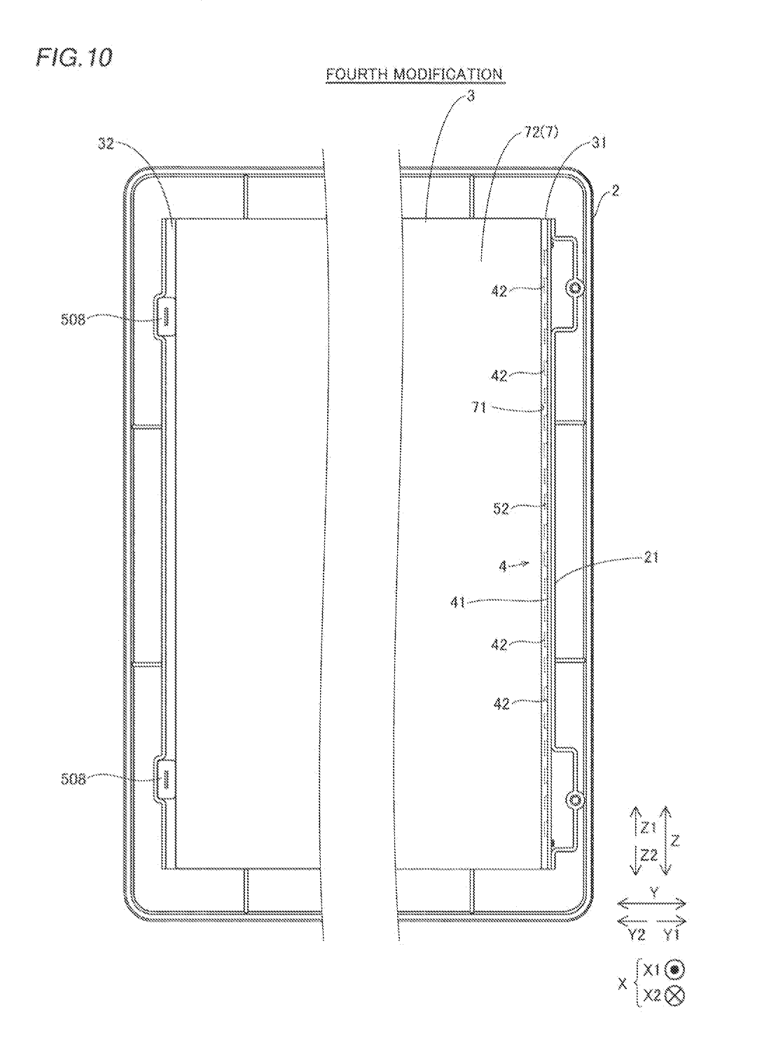

While the silicon rubbers as the urging member according to the present invention urge the protrusion portions of the light guide plate in each of the aforementioned first and second embodiments, the present invention is not restricted to this. According to the present invention, the urging member may alternatively urge a portion of the light guide plate other than the protrusion portion. Specifically, silicon rubbers 508 as the urging member may alternatively urge a surface of a light guide plate opposite to a light incident surface, as in a fourth modification shown in FIG. 10.

While the urging member according to the present invention is a silicon rubber in each of the aforementioned first and second embodiments, the present invention is not restricted to this. According to the present invention, a leaf spring or a resin spring other than the silicon rubber, for example may alternatively be used as the urging member.

What is claimed is:

1. A display device comprising:
a display device body;
a display portion arranged on a front side of the display device body, displaying an image;
a light source supplying light to the display portion;
a light source substrate mounted with the light source;
a light guide plate having a light incident surface receiving light emitted from the light source, guiding the light to the display portion; and
a heat sink arranged to be opposed to the light incident surface of the light guide plate between the light guide plate and the light source substrate, including a light source arrangement hole configured to arrange the light source and a spacer portion arranged to be opposed to the light incident surface of the light guide plate between the light guide plate and the light source substrate and keeping an interval between the light incident surface of the light guide plate and the light source at a prescribed interval.

2. The display device according to claim 1, wherein
the light incident surface of the light guide plate is configured to come into contact with the spacer portion of the heat sink in a state where the light source is arranged in the light source arrangement hole of the heat sink.

3. The display device according to claim 2, wherein
the light incident surface of the light guide plate is substantially flat, and
the spacer portion is formed such that a portion thereof opposed to the light incident surface of the light guide plate has a substantially flat surface.

4. The display device according to claim 1, wherein
the spacer portion has a thickness larger than a protrusion height of the light source from a mounting surface of the light source substrate in a state where the light source is arranged in the light source arrangement hole.

5. The display device according to claim 1, wherein
the light source is mounted on a surface of the light source substrate opposed to the light guide plate, and
the light source substrate is configured such that the surface thereof opposed to the light guide plate is fixed to a surface of the spacer portion opposite to a side opposed to the light guide plate.

6. The display device according to claim 1, wherein
the light source substrate includes a wiring pattern, and
a larger number of wiring patterns are provided in a vicinity of a surface of the light source substrate closer to the heat sink, than in a vicinity of a surface of the light source substrate opposite to the heat sink.

7. The display device according to claim 1, further comprising an urging member urging the light guide plate toward the spacer portion in a state where the light source is arranged in the light source arrangement hole.

8. The display device according to claim 7, wherein
a plurality of urging members are provided, and
the plurality of urging members are provided at positions on both end sides of the light incident surface of the light guide plate, respectively.

9. The display device according to claim 1, wherein
a plurality of light sources are provided,
the spacer portion includes a plurality of light source arrangement holes at positions corresponding to the plurality of light sources, and
the light guide plate is arranged to come into contact with a region of the spacer portion between the plurality of light source arrangement holes adjacent to each other.

10. The display device according to claim 9, wherein
the region of the spacer portion between the plurality of light source arrangement holes adjacent to each other has a width equal to or more than a thickness of the light guide plate in an anteroposterior direction.

11. The display device according to claim 1, further comprising a rear frame arranged on a rear side of the heat sink, wherein
the light source substrate is fixed to a surface of the spacer portion opposite to a side opposed to the light guide plate in a state where a rear side end surface of the light source substrate is separated from a front side of the rear frame at a prescribed interval.

12. The display device according to claim 11, wherein
the light source substrate includes a first positioning portion, and
the spacer portion includes a second positioning portion corresponding to the first positioning portion.

13. The display device according to claim 1, further comprising a second heat sink provided separately from a first heat sink as the heat sink, arranged on a surface of the light source substrate opposite to a side on which the first heat sink is arranged.

14. The display device according so claim 1, wherein
the light source and the light source arrangement hole are formed in shapes corresponding to each other, as viewed from a side of the light incident surface of the light guide plate.

15. The display device according to claim 1, wherein
the light source includes an LED light source, and
the LED light source is arranged in the light source arrangement hole.

16. The display device according to claim 11, wherein
the rear frame includes a restriction portion restricting movement of the heat sink in a state where the light source is arranged in the light source arrangement hole of the heat sink and the light incident surface of the light guide plate comes into contact with the spacer portion of the heat sink.

17. The display device according to claim 1, wherein the heat sink is made of a plate-like metal material.

18. The display device according to claim 1, being a television set including a receiver receiving television broadcasting.
